(19) United States
(12) Patent Application Publication
(10) Pub. No.: US 2007/0087143 A1
(43) Pub. Date: Apr. 19, 2007

(54) Sleeve and molding device containing the same

(75) Inventor: Jiann-Nan Lin, Tan-Tzu Hsiang (TW)

Correspondence Address: BIRCH STEWART KOLASCH & BIRCH, PO BOX 747, FALLS CHURCH, VA, 22040-0747, US

(73) Assignee: ASIA OPTICAL CO., INC.

(21) Appl. No.: 11/505,348

(22) Filed: Aug. 17, 2006

(30) Foreign Application Priority Data
Oct. 13, 2005 (TW) 094135697

(51) Int. Cl. B28B 11/00; B32B 15/04; F16L 9/10; C03B 23/00; C03B 11/08

(52) U.S. Cl. 428/34.4; 428/457; 65/286; 65/374.11

(57) ABSTRACT

A molding device for molding glass includes a sleeve, an upper mold core, and a lower mold core. The sleeve includes a multi-layer sleeve wall that has a first tubular wall defining a mold cavity, and a second tubular wall surrounding concentrically the first tubular wall. The first tubular wall has a first thermal conductivity coefficient. The second tubular wall has a second thermal conductivity coefficient smaller than the first thermal conductivity coefficient. The upper mold core is inserted axially into the mold cavity. The lower mold core is inserted axially into the mold cavity below the upper mold core.

### CROSS-REFERENCE TO RELATED APPLICATION

This application claims priority of Taiwanese Application No. 094135697, filed on Oct. 13, 2005.

### BACKGROUND OF THE INVENTION

1. Field of the Invention

The invention relates to a sleeve, more particularly to a sleeve that can reduce heat transfer in radial directions. The invention also relates to a molding device containing the sleeve.

2. Description of the Related Art

Referring to FIG. 1, a conventional molding device 1 for molding glass includes a sleeve 11, an upper mold core 12 inserted axially into the sleeve 11, and a lower mold core 13 inserted axially into the sleeve 11 below the upper mold core 12.

After a glass material 2 is disposed on the lower mold core 13 in the sleeve 11 of the molding device 1, the upper mold core 12 is inserted axially into the sleeve 11 to close the molding device 1. The molding device 1 is then placed in a forming chamber 3 to conduct a molding process through a preheating station (H1), a heating station (H2), a pre-pressing station (P1), a pressing station (P2), a first cooling station (C1), a second cooling station (C2), and a third cooling station (C3) in sequence. Thereafter, the upper mold core 12 is removed from the sleeve 11 of the molding device 1 to take a molded glass out of the sleeve 11 of the molding device 1.

The forming chamber 3 further includes two pairs of heating plates 31,32 corresponding to the preheating station (H1) and the heating station (H2), respectively, two pairs of pressing plates 33,34 corresponding to the pre-pressing station (P1) and the pressing station (P2), respectively, and three pairs of cooling plates 35,36,37 corresponding to the first, second and third cooling stations (C1,C2,C3), respectively. When the molding device 1 is transported from the preheating station (H1) to the third cooling station (C3) in the forming chamber 3, the temperature in the sleeve 11 required for processing the glass material at each of the stations (H1,H2,P1,P2,C1,C2,C3) is achieved by thermal conductivity through the upper and lower mold cores 12,13 and the sleeve 11.

However, since the preheating station (H1), the heating station (H2), the pre-pressing station (P1), the pressing station (P2), and the first, second, and third cooling stations (C1,C2,C3) of the forming chamber 3 are communicated with each other, it is difficult to control accurately the temperature in the sleeve 11 required specifically for each of the stations (H1,H2,P1,P2,C1,C2,C3) due to thermal radiation and thermal convection. For example, when the molding device 1 is transported into the pre-pressing station (P1), the heat energy of the heating station (H2) is transmitted to the portion of the sleeve 11 proximate to the heating station (H2), and the heat energy of the portion of the sleeve 11 proximate to the pressing station (P2) is dispersed toward the pressing station (P2) due to the fact that the temperature in the pre-pressing station (P1) is lower than that in the heating station (H2) and higher than that in the pressing station (P2). Therefore, the temperature of the portion of the sleeve 11 proximate to the pressing station (P2) is lower than that of the portion of the sleeve 11 proximate to the heating station (H2). Such a temperature difference between the two portions of the sleeve 11 may result in a reduced precision of a molded glass 2′, as shown in FIG. 2.

### SUMMARY OF THE INVENTION

Therefore, the object of the present invention is to provide a sleeve which can reduce heat transfer in radial directions so as to overcome the aforesaid disadvantage of the prior art, thereby producing a molded glass having a relatively high precision.

In one aspect of this invention, a molding device for molding glass includes a sleeve, an upper mold core, and a lower mold core. The sleeve includes a multi-layer sleeve wall that has a first tubular wall defining a mold cavity, and a second tubular wall surrounding concentrically the first tubular wall. The first tubular wall has a first thermal conductivity coefficient. The second tubular wall has a second thermal conductivity coefficient smaller than the first thermal conductivity coefficient. The upper mold core is inserted axially into the mold cavity. The lower mold core is inserted axially into the mold cavity below the upper mold core.

In another aspect of this invention, a sleeve is adapted to be used in a molding device having an upper mold core and a lower mold core spaced apart from each other. The sleeve includes a multi-layer sleeve wall that includes a first tubular wall and a second tubular wall. The first tubular wall defines a mold cavity for receiving the upper and lower mold cores. The second tubular wall surrounds the first tubular wall. The first tubular wall has a first thermal conductivity coefficient. The second tubular wall has a second thermal conductivity coefficient smaller than the first thermal conductivity coefficient.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view of a conventional molding device undergoing a molding process in a forming chamber;

FIG. 2 is a schematic view of a molded glass made using the conventional molding device;

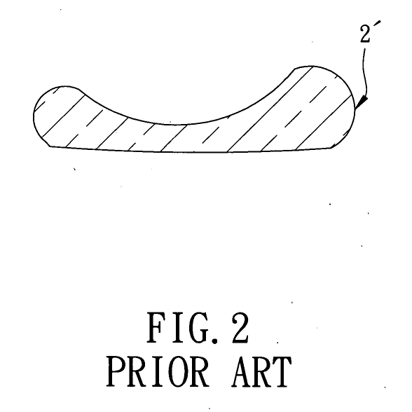

FIG. 3 is a cross-sectional view of the first preferred embodiment of a sleeve according to this invention;

FIG. 4 is a cross-sectional view of the preferred embodiment of a molding device according to this invention, in which the first preferred embodiment of the sleeve is used;

FIG. 5 is a cross-sectional view of the first example of the second preferred embodiment of a sleeve according to this invention;

FIG. 6 is a cross-sectional view of the second example of the second preferred embodiment of a sleeve according to this invention; and

FIG. 7 is a cross-sectional view of the third example of the second preferred embodiment of a sleeve according to this invention.

### DETAILED DESCRIPTION OF THE PREFERRED EMBODIMENTS

Before the present invention is described in greater detail, it should be noted that like elements are denoted by the same reference numerals throughout the disclosure.

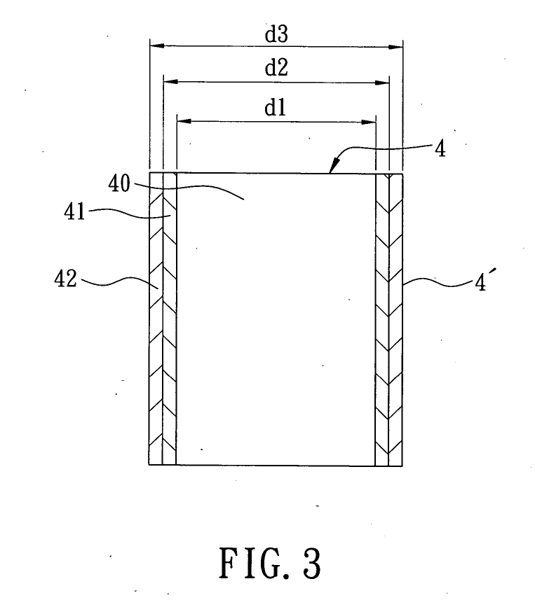

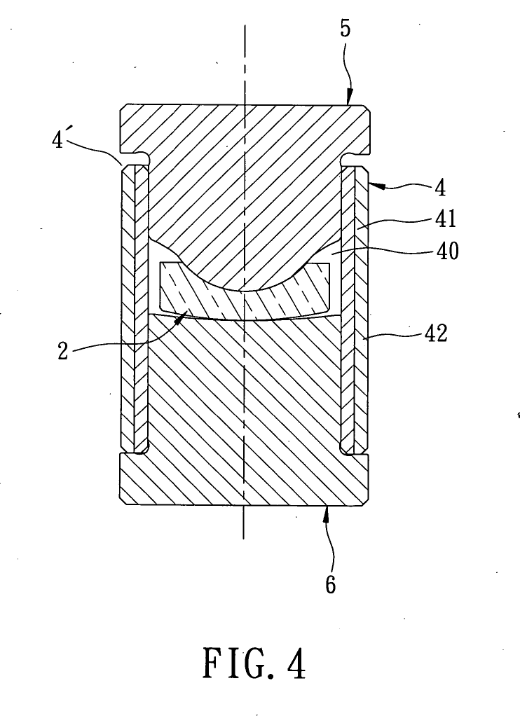

Referring to FIGS. 3 and 4, the preferred embodiment of a molding device for molding glass according to this invention includes a sleeve 4, an upper mold core 5, and a lower mold core 6.

In the first preferred embodiment, the sleeve 4 includes a multi-layer sleeve wall 4′ that has a first tubular wall 41 defining a mold cavity 40, and a second tubular wall 42 surrounding concentrically the first tubular wall 41. The material suitable for the first tubular wall 41 is tungsten carbide, ceramic, or the like. The first tubular wall 41 has a first thermal conductivity coefficient (k1). The material suitable for the second tubular wall 42 includes stainless steel, super-hard alloy, or the like. The second tubular wall 42 has a second thermal conductivity coefficient (k2) smaller than the first thermal conductivity coefficient (k1). The terms “super-hard alloy” used in this invention is meant to be an alloy having a hardness (HRA) greater than 90. Examples of the super-hard alloy suitable for this invention are metal carbide, such as tungsten carbide; ceramic carbide, such as silicon carbide; or the like.

The upper mold core 5 is inserted axially into the mold cavity 40. The lower mold core 6 is inserted axially into the mold cavity 40 below the upper mold core 5. Each of the upper and lower mold cores 5,6 is made of tungsten carbide in this example.

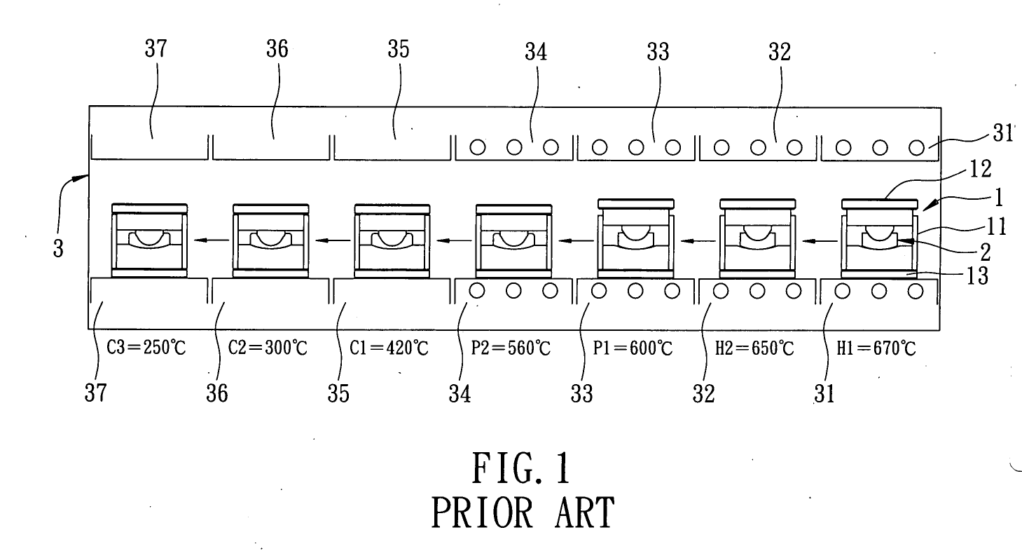

Heat is transferred into the mold cavity 40 primarily through the upper and lower mold cores 5,6 by thermal conductivity so as to provide a glass material 2 in the mold cavity 40 with the required temperature for each of the processing stations of a conventional forming chamber (see FIG. 1).

The thermal conductivity is influenced by heat transferring rate (q), which is defined by the following equation:

$$q = \frac{Δ T}{R}$$

wherein ΔT is a temperature difference between two mediums; and R is heat resistance.

According to the aforesaid equation, the higher the heat resistance, the lower will be the heat transferring rate. Therefore, the heat transferring rate can be lowered by increasing the heat resistance of the sleeve 4 so as to lower the thermal conductivity of the sleeve 4. As a result, the influence of the temperatures of the processing stations proximate to the molding device upon the sleeve 4 can be reduced to avoid the aforesaid problem of the prior art. However, it should be noted that the glass material 2 in the sleeve 4 should reach the required temperature for each of the processing stations. Therefore, the axial heat transferring rate through the upper and lower mold cores 5,6 should be sufficient to reach the desired temperature levels while reducing the heat transferring rate through the sleeve 4.

For a sleeve having a cylindrical geometry, the radial heat resistance (R) can be calculated according to the following equation:
R=ln(dₒ/dᵢ)/2πkL
wherein:
dᵢ=inner diameter;
dₒ=outer diameter;
k=thermal conductivity coefficient;
L=length.

Referring again to FIG. 1, a comparative example of the conventional sleeve 11 is made entirely of tungsten carbide, and has a thermal conductivity coefficient (k) of 75 W/m-K, an inner diameter (dᵢ) of 14.7 mm, an outer diameter (dₒ) of 18.7 mm, and a length (L) of 21.9 mm. According to the aforesaid equation, the radial heat resistance (R) of the conventional sleeve 11 is 0.023 K/W, i.e.,

$$\begin{matrix}R = ln ( {d}_{o} / {d}_{i} ) / 2 π kL \\ = ln ( 18.7 / 14.7 ) / 2 π \times 75 \times 21.9 \times {10}^{- 3} \\ = 0.023 K / W .\end{matrix}$$

Referring again to FIG. 3, an illustrative example of the sleeve 4 of the first preferred embodiment has a length (L) of 21.9 mm, and includes a first tubular wall 41 made of tungsten carbide and a second tubular wall 42 made of stainless steel (SUS316). The first thermal conductivity coefficient (k1) of the first tubular wall 41 is 75 W/m-K. The second thermal conductivity coefficient (k2) of the second tubular wall 42 is 21.4 W/m-K. The inner diameter (d1) of the first tubular wall 41 is 14.7mm. The outer diameter (d2) of the first tubular wall 41 (i.e., the inner diameter of the second tubular wall 42) is 16.7 mm. The outer diameter (d3) of the second tubular wall 42 is 18.7 mm. According to the aforesaid equation, the radial heat resistance (R) of the sleeve 4 is 0.051 K/W, i.e.,

$$\begin{matrix}R = ln ( ⅆ 2 / ⅆ 1 ) / 2 π k 1 L + ln ( ⅆ 3 / ⅆ 2 ) / 2 π k 2 L \\ = ln ( 16.7 / 14.7 ) / 2 π \times 75 \times 21.9 \times {10}^{- 3} + \\ ln ( 18.7 / 16.7 ) / 2 π \times 21.4 \times 21.9 \times {10}^{- 3} \\ = 0.051 K / W .\end{matrix}$$

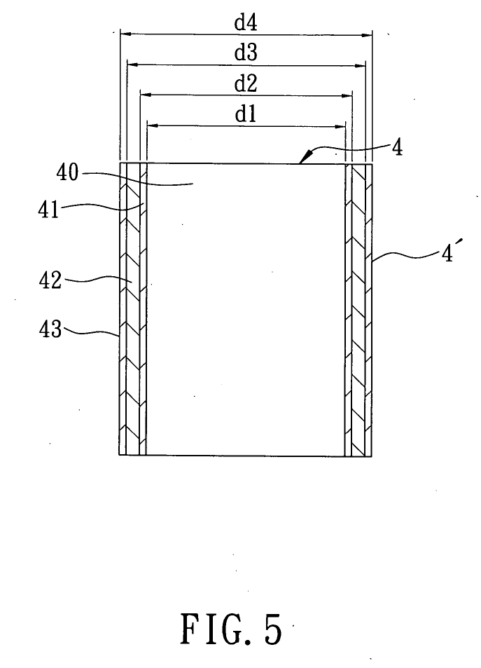

Referring to FIG. 5, the sleeve 4 of the second preferred embodiment is similar to that of the first preferred embodiment, except that the sleeve wall 4′ of the sleeve 4 of the second preferred embodiment further includes a third tubular wall 43 surrounding concentrically the second tubular wall 42. The material suitable for the third tubular wall 43 is stainless steel, super-hard alloy, or the like. The third tubular wall 43 has a third thermal conductivity coefficient (k3) smaller than the first thermal conductivity coefficient (k1) and different from the second thermal conductivity coefficient (k2).

In the first illustrative example of this preferred embodiment, the sleeve 4 has a length (L) of 21.9 mm. The first tubular wall 41 is made of tungsten carbide, and has a first thermal conductivity coefficient (k1) of 75 W/m-K. The second tubular wall 42 is made of stainless steel (SUS410), and has a second thermal conductivity coefficient (k2) of 28.7 W/m-K. The third tubular wall 43 is made of stainless steel (SUS316), and has a third thermal conductivity coefficient (k3) of 21.4 W/m-K. The inner diameter (d1) of the first tubular wall 41 is 14.7mm. The outer diameter (d2) of the first tubular wall 41 (i.e., the inner diameter of the second tubular wall 42) is 15.7mm. The outer diameter (d3) of the second tubular wall 42 (i.e., the inner diameter of the third tubular wall 43) is 17.7 mm. The outer diameter (d4) of the third tubular wall 43 is 18.7 mm. According to the aforesaid equation, the radial heat resistance (R) of the sleeve 4 is 0.055 K/W, i.e.,

$$\begin{matrix}R = ln ( ⅆ 2 / ⅆ 1 ) / 2 π k 1 L + ln ( ⅆ 3 / ⅆ 2 ) / 2 π k 2 L + ln ( ⅆ 4 / ⅆ 3 ) / 2 π k 3 L \\ = ln ( 15.7 / 14.7 ) / 2 π \times 75 \times 21.9 \times {10}^{- 3} + ln ( 17.7 / 15.7 ) / 2 π \times \\ 28.7 \times 21.9 \times {10}^{- 3} + ln ( 18.7 / 17.7 ) / 2 π \times 21.4 \times 21.9 \times {10}^{- 3} \\ = 0.055 K / W .\end{matrix}$$

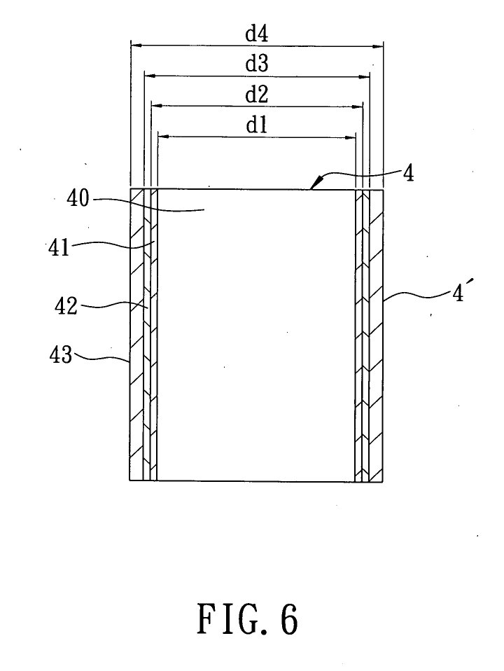

Referring to FIG. 6, the second illustrative example of the sleeve 4 of the second preferred embodiment is similar to the example of FIG. 5, except that the inner diameter (d1) of the first tubular wall 41 is 14.7mm. The outer diameter (d2) of the first tubular wall 41 (i.e., the inner diameter of the second tubular wall 42) is 15.7mm. The outer diameter (d3) of the second tubular wall 42 (i.e., the inner diameter of the third tubular wall 43) is 16.7 mm. The outer diameter (d4) of the third tubular wall 43 is 18.7 mm. According to the aforesaid equation, the radial heat resistance (R) of the sleeve 4 is 0.0604 K/W, i.e.,

$$\begin{matrix}R = ln ( ⅆ 2 / ⅆ 1 ) / 2 π k 1 L + ln ( ⅆ 3 / ⅆ 2 ) / 2 π k 2 L + ln ( ⅆ 4 / ⅆ 3 ) / 2 π k 3 L \\ = ln ( 15.7 / 14.7 ) / 2 π \times 75 \times 21.9 \times {10}^{- 3} + ln ( 16.7 / 15.7 ) / 2 π \times \\ 28.7 \times 21.9 \times {10}^{- 3} + ln ( 18.7 / 16.7 ) / 2 π \times 21.4 \times 21.9 \times {10}^{- 3} \\ = 0.0604 K / W .\end{matrix}$$

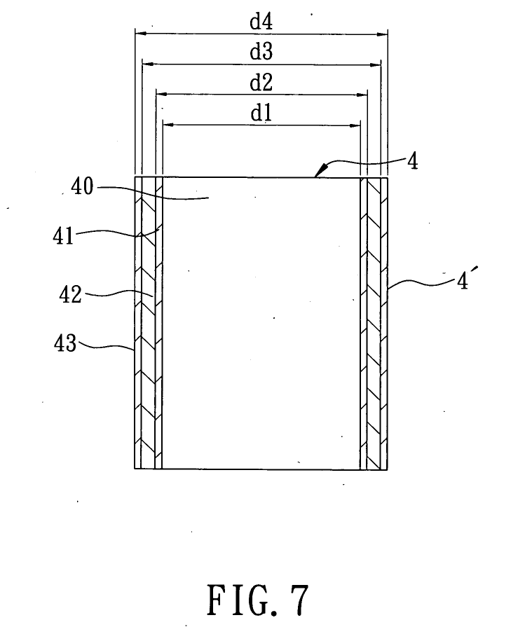

Referring to FIG. 7, the third illustrative example of the sleeve 4 of the second preferred embodiment is similar to the example of FIG. 5, except that the first tubular wall 41 is made of tungsten carbide, and has a first thermal conductivity coefficient (k1) of 75 W/m-K. The second tubular wall 42 is made of stainless steel (SUS316) , and has a second thermal conductivity coefficient (k2) of 21.4 W/m-K. The third tubular wall 43 is made of stainless steel (SUS410), and has a third thermal conductivity coefficient (k3) of 28.7 W/m-K. According to the aforesaid equation, the radial heat resistance (R) of the sleeve 4 is 0.0610 K/W, i.e.,

$$\begin{matrix}R = ln ( ⅆ 2 / ⅆ 1 ) / 2 π k 1 L + ln ( ⅆ 3 / ⅆ 2 ) / 2 π k 2 L + ln ( ⅆ 4 / ⅆ 3 ) / 2 π k 3 L \\ = ln ( 15.7 / 14.7 ) / 2 π \times 75 \times 21.9 \times {10}^{- 3} + ln ( 16.7 / 15.7 ) / 2 π \times \\ 21.4 \times 21.9 \times {10}^{- 3} + ln ( 18.7 / 16.7 ) / 2 π \times 28.7 \times 21.9 \times {10}^{- 3} \\ = 0.0610 K / W .\end{matrix}$$

The variables and the characteristics of the conventional sleeve 11 and the examples of the sleeve 4 of this invention are summarized in the following table.

TABLE

| | | | | | Thermal | | | | | | | |
|---|---|---|---|---|---|---|---|---|---|---|---|---|
| | | | | | conductivity | | | | | | | |
| | | | | | coefficient | | | | | | | |
| | L | Tubular wall | | | W/m-k | | | d1(di) | do mm | | | R |
| | Mm | 1st | 2nd | 3rd | k1 | k2 | k3 | mm | d2 | d3 | d4 | K/W |
| Con.¹ | 21.9 | WC⁶ | | | 75 | | | 14.7 | 18.7 | | | 0.023 |
| #1² | 21.9 | WC | SUS316 | | 75 | 21.4 | | 14.7 | 16.7 | 18.7 | | 0.051 |
| #2³ | 21.9 | WC | SUS410 | SUS316 | 75 | 28.7 | 21.4 | 14.7 | 15.7 | 17.7 | 18.7 | 0.055 |
| #3⁴ | 21.9 | WC | SUS410 | SUS316 | 75 | 28.7 | 21.4 | 14.7 | 15.7 | 16.7 | 18.7 | 0.0604 |
| #4⁵ | 21.9 | WC | SUS316 | SUS410 | 75 | 21.4 | 28.7 | 14.7 | 15.7 | 17.7 | 18.7 | 0.0610 |

¹conventional sleeve
²the first preferred embodiment of the sleeve of this invention
³the first example of the second preferred embodiment of the sleeve of this invention
⁴the second example of the second preferred embodiment of the sleeve of this invention
⁵the third example of the second preferred embodiment of the sleeve of this invention
* WC = Tungsten carbide

It is apparent from the above table that the radial heat resistance (R) of the sleeve 4 of this invention is increased significantly as compared to that of the conventional sleeve 11. Therefore, the radial heat transferring rate (q) of the sleeve 4 of this invention is reduced significantly. As a result, heat exchange in radial directions through the sleeve 4 can be reduced. On the other hand, since the first tubular wall 41, which contacts the upper and lower mold cores 5,6, has a first thermal conductivity coefficient (k1) larger than the second thermal conductivity coefficient (k2) of the second tubular wall 42 and the third thermal conductivity coefficient (k3) of the third tubular wall 43, the temperature within the sleeve 4 desirable for each of the processing stations of the molding process can still be achieved by heat transmitted through the upper and lower mold cores 5,6. Therefore, the precision of a molded glass made by the molding device of this invention can be improved.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A molding device for molding glass, comprising:
a sleeve including a multi-layer sleeve wall that has a first tubular wall defining a mold cavity, and a second tubular wall surrounding concentrically said first tubular wall, said first tubular wall having a first thermal conductivity coefficient, said second tubular wall having a second thermal conductivity coefficient smaller than the first thermal conductivity coefficient;
an upper mold core inserted axially into said mold cavity; and
a lower mold core inserted axially into said mold cavity below said upper mold core.

2. The molding device as claimed in claim 1, wherein each of said upper and lower mold cores includes a material of tungsten carbide.

3. The molding device as claimed in claim 1, wherein said first tubular wall includes a material selected from the group consisting of tungsten carbide and ceramic, and said second tubular wall contains a material selected from the group consisting of stainless steel and super-hard alloy.

4. The molding device as claimed in claim 3, wherein said first tubular wall includes a material of tungsten carbide, and said second tubular wall includes a material of stainless steel.

5. The molding device as claimed in claim 1, wherein said multi-layer sleeve wall further includes a third tubular wall surrounding said second tubular wall, and having a third thermal conductivity coefficient smaller than the first thermal conductivity coefficient and different from the second thermal conductivity coefficient.

6. The molding device as claimed in claim 5, wherein said third tubular wall includes a material selected from the group consisting of stainless steel and super-hard alloy.

7. The molding device as claimed in claim 6, wherein said third tubular wall includes a material of stainless steel.

8. A sleeve adapted to be used in a molding device having an upper mold core and a lower mold core spaced apart from each other, said sleeve comprising a multi-layer sleeve wall that includes:
a first tubular wall defining a mold cavity for receiving the upper and lower mold cores; and
a second tubular wall surrounding said first tubular wall;
wherein said first tubular wall has a first thermal conductivity coefficient, said second tubular wall having a second thermal conductivity coefficient smaller than the first thermal conductivity coefficient.

9. The sleeve as claimed in claim 8, wherein said first tubular wall includes a material selected from the group consisting of tungsten carbide and ceramic, said second tubular wall including a material selected from the group consisting of stainless steel and super-hard alloy.

10. The sleeve as claimed in claim 9, wherein said first tubular wall includes a material of tungsten carbide, said second tubular wall including a material of stainless steel.

11. The sleeve as claimed in claim 8, wherein said multi-layer sleeve wall further includes a third tubular wall surrounding said second tubular wall, and having a third thermal conductivity coefficient smaller than the first thermal conductivity coefficient and different from the second thermal conductivity coefficient.

12. The sleeve as claimed in claim 11, wherein said third tubular wall includes a material selected from the group consisting of stainless steel and super-hard alloy.

13. The sleeve as claimed in claim 12, wherein said third tubular wall includes a material of stainless steel.
